(19) United States
(12) Patent Application Publication
(10) Pub. No.: US 2012/0077027 A1
(43) Pub. Date: Mar. 29, 2012

(54) REACTIVE COMPATIBILIZED MULTI-LAYER HEAT-SHRINKABLE COATING

(75) Inventor: Marcia E. Navarro, Tijuana BC (MX)

(73) Assignee: BERRY PLASTICS CORPORATION, Evansville, IN (US)

(21) Appl. No.: 13/240,828

(22) Filed: Sep. 22, 2011

Related U.S. Application Data
(60) Provisional application No. 61/385,826, filed on Sep. 23, 2010.

(51) Int. Cl. B32B 7/12

(52) U.S. Cl. 428/343

(57) ABSTRACT

A multi-layer coating includes an adhesive layer, a tying layer, and a polyolefin sheet. A multi layer coating may include at least one tying layer interposed between and in contact with an adhesive layer and a heat-shrinkable polyolefin sheet.

### PRIORITY CLAIM

This application claims priority under 37 U.S.C. §119(e) to U.S. Provisional Application Ser. No. 61/385,826, filed Sep. 23, 2010, which is expressly incorporated by reference herein.

### BACKGROUND

The present disclosure relates to a heat-shrinkable coating, in particular, a heat-shrinkable coating with an adhesive. More particularly, the present disclosure relates to a heat-shrinkable coating with an adhesive for covering a steel pipe joint.

Pipes are sold and transported in lengths which may be much shorter than their useful lengths. For example, a given application may require several miles of pipe to be laid, but manufacturing and transporting a pipe with a length of several miles is not practical. Therefore, pipes may be produced in significantly shorter lengths, such as 20, 40 or 80 foot long sections and then assembled together in the field. Metals and/or alloys, such as steel, are routinely used in the manufacture of pipes. During installation, the pipe sections can be welded together at their ends, for example, by butt-welding, to form a single pipe with an extended length.

During the manufacture of pipes, protective coatings may be installed on the surface of the pipe to protect the pipe's metal from oxidation, abrasion, and degradation. Coatings differ vastly based on the application. For example, multilayer polyethylene or polypropylene, fusion bonded epoxy (FBE), enamel, and/or rubber coatings may be used to protect a pipe depending on the environmental conditions to which the pipes will be exposed. During manufacturing, the end portions of a pipe section are left uncoated so that the pipe section can be welded together during installation without interference from or damage to the protective coating. After the pipes are welded, the unprotected end sections and the welded joint may be protected using a sleeve or coating. In combination with the protective coating installed during manufacture, the sleeve allows the protective coating to be continuous over the length of pipe.

### SUMMARY

A joint-covering sleeve in accordance with the present disclosure includes a polyolefin sheet and an adhesive layer. In illustrative embodiments, the joint-covering sleeve is configured as a tubular sleeve. In another embodiment, the joint-covering sleeve is configured as a sheet which can be further configured as a wraparound sleeve during installation.

In illustrative embodiments, disclosed is a joint-covering sleeve for covering an outer surface of a pipe. The joint-covering sleeve comprises a polyolefin sheet, a tying layer, and an adhesive layer. The tying layer is interposed between and in contact with the polyolefin sheet and the adhesive layer and the tying layer includes tying means for coupling the polyolefin sheet to the adhesive layer to retain the polyolefin sheet and the adhesive layer on the pipe. In one embodiment, the tying means includes an amount of a reactively modified polyolefin dispersed in the tying layer to provide non-reactive compatibilization to the polyolefin sheet and reactive compatibilization towards the adhesive layer. In another embodiment, the tying means provides retention of the polyolefin sheet and the adhesive layer on the pipe so that the joint-covering sleeve resists cathodic disbondment according to ASTM G42.

In illustrative embodiments, the joint-covering sleeve comprises a polyolefin sheet comprising an irradiation cross-linked polymer such as polyethylene, polypropylene, or a blend thereof. In one embodiment, contact between the tying layer and the adhesive layer is such that the reactively modified polyolefin covalently bonds with the polymer making up the adhesive layer. In another embodiment, the joint-covering sleeve resists cathodic disbondment as measure according to ASTM G42. For example, a joint-covering sleeve may exhibit a cathodic disbondment of less than about 6 mm in 30 days at 50° C.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a pipeline in an underground installation showing a partial perspective view of a pipeline and a sleeve in accordance with the present disclosure and showing that the joint-covering sleeve is arranged (in a manner suggested, for example, in FIGS. 10-13) to cover a joint (shown in phantom) between two steel pipes that are included in the pipeline and that have been butt-welded and showing a diagrammatic cathodic protection system used to prevent corrosion of the pipeline;

FIG. 2 is an enlarged sectional view taken about line 2-2 of FIG. 1 showing that the pipeline further includes an exterior pipe-coating layer made of a plastics material applied to each of the first and second steel pipes and showing that the sleeve is made of a shrink-wrap material comprising three layers and includes a left-end portion bonded to the exterior pipe-coating layer on the first steel pipe, a right-end portion bonded to the exterior pipe-coating layer on the butt-welded second steel pipe, and a central portion arranged to cover and bond to the steel pipes and the joint exposed between the first and second exterior pipe-coating layers;

FIG. 3 is a enlarged perspective view of the pipeline of FIG. 1 showing the joint-covering sleeve covering the first plastics coating, the steel pipes, and the butt-weld (all shown in phantom except for that portion of the second steel pipe shown extending beyond the broken-away joint-covering sleeve showing that the cathodic protection system is connected to the steel pipe), and showing that the joint-covering sleeve has been nicked by an external nick producer (shown diagrammatically) to form in the sleeve an aperture (often called a “nick” or a “holiday”) exposing an exterior surface of the underlying steel pipe and interior edges of the shrink-wrap material included in the joint-covering sleeve;

FIG. 4 is a sectional view taken about the line 4-4 of FIG. 3 showing that the “holiday” defined by the aperture formed in the joint-covering sleeve is characterized by a dimension D1 and showing that any disbondment (i.e. separation) of joint-covering sleeve from the first steel pipe at the holiday is insubstantial;

FIG. 5 is a sectional view of a prior art sleeve on a pipeline showing disbondment of the sleeve from the pipeline at a holiday formed in the sleeve and showing that the disbondment is characterized by a dimension D2;

FIG. 6A-B are sectional views of a sleeve on a pipeline showing that the sleeve can be tested for resistance to disbondment according to the procedure of ASTM G42; the method of ASTM G42 including producing a standard-sized holiday in a coating with a drill bit (FIG. 6A) and testing disbondment at the resulting holiday after the drill bit is removed (FIG. 6B);

FIG. 7 is a diagrammatic representation of a first embodiment of the shrink-wrap material used to form the joint-covering sleeve of FIGS. 1-4 showing that an adhesive layer is adapted to be coupled to the pipeline, a polyolefin sheet is arranged to provide an exterior skin of the joint-covering sleeve, and a tying layer is interposed between the adhesive layer and the polyolefin sheet and bonded to the adhesive layer using reactive compatibilization and to the polyolefin sheet using non-reactive compatibilization;

FIG. 8 is a diagrammatic view of one embodiment of the polyolefin sheet showing a fibrous layer interposed between and in contact with a first polyolefin layer and a second polyolefin layer;

FIG. 9 is a diagrammatic view of another embodiment of a shrink-wrap material showing a release liner may be adapted to contact the adhesive layer to block unintended adhesion;

FIG. 10-13 are illustrations suggesting a manner in which a wrap-around sleeve is arranged to cover a joint between two steel pipes that are included in a pipeline the two steel pipes butt-welded at the joint;

FIG. 10 is a perspective view of a roll of the shrink-wrap material showing, as a dotted line, a location for cutting from the role an amount of shrink-wrap material to cover the joint, further showing the manner in which the wrap-around sleeve is oriented with respect to the pipeline to cover the exterior pipe-coating layer on the first steel pipe, the exterior pipe-coating layer on the butt-welded second steel pipe, and the central portion arranged to cover and bond to the steel pipes and the joint-weld exposed between the first and second exterior pipe-coating layers;

FIG. 11 is a perspective view of the wrap-around sleeve of FIG. 10 showing that the sleeve has been wrapped around the pipe and held in place by a clamp with a break-away showing the joint, the steel pipes, and the first and second plastics exterior pipe coating layers;

FIG. 12 is a partial perspective view similar to FIG. 11 showing the use of a torch to apply heat to all exposed exterior surfaces of the sleeve to cause the heat-shrink woven material of the sleeve to shrink; and

FIG. 13 is a partial perspective view similar to FIG. 11 after heat has been applied and the clamp has been removed, the heat-shrinkable coating encloses the joint.

### DETAILED DESCRIPTION

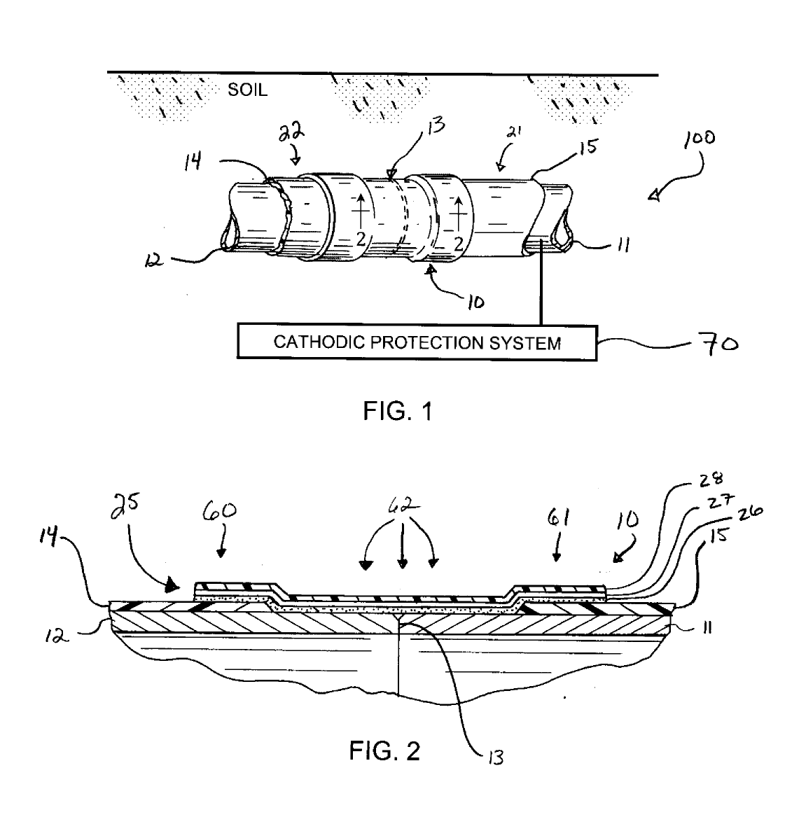

As suggested in FIG. 1, a joint-covering sleeve 10 covers a pipeline 100, illustratively shown in an underground installation with a cathodic protection system 70 (shown diagrammatically), at a joint 13 (shown in phantom) in which a first steel pipe 11 is butt-welded to a second steel pipe 12. Pipeline 100 includes a first and second exterior pipe-coating layer 14 and 15 made of a plastics material applied to steel pipes that make up pipeline 100. Exterior pipe-coating layers 14 and 15 are installed during manufacture of pipeline 100, but do not coat the end portions of first and second steel pipes 11, 12 so that the pipes can be welded together.

One purpose of exterior pipe-coating layers 14 and 15 and joint-covering sleeve 10 is to prevent to liquids (e.g. water), soil, and vapors from contacting steel pipes 11, 12. While exterior pipe-coating layers 14 and 15 are installed during manufacturing, joint-covering sleeve 10 is applied to pipeline 100 after joint 13 has been welded, thus installation occurs where pipeline 100 is installed. In addition to the corrosion protection afforded by the covering, pipeline 100 includes cathodic protection system 70 to protect pipeline 100 further from corrosion.

Referring now to FIG. 2, the pipeline includes exterior pipe-coating layers 14 and 15 made of a plastics material and applied to each of the first and second steel pipes 11 and 12. Joint-covering sleeve 10 is made of a shrink-wrap material 25 comprising three layers. Sleeve 10 includes a left end portion bonded 60 to second exterior pipe-coating layer 15 on second steel pipe 12, a right-end portion bonded 61 to first exterior pipe-coating layer 14 on the butt-welded first steel pipe 11, and a central portion 62 arranged to cover and bond to steel pipes 11 and 12 and joint 13 exposed between first and second exterior pipe-coating layers 14 and 15.

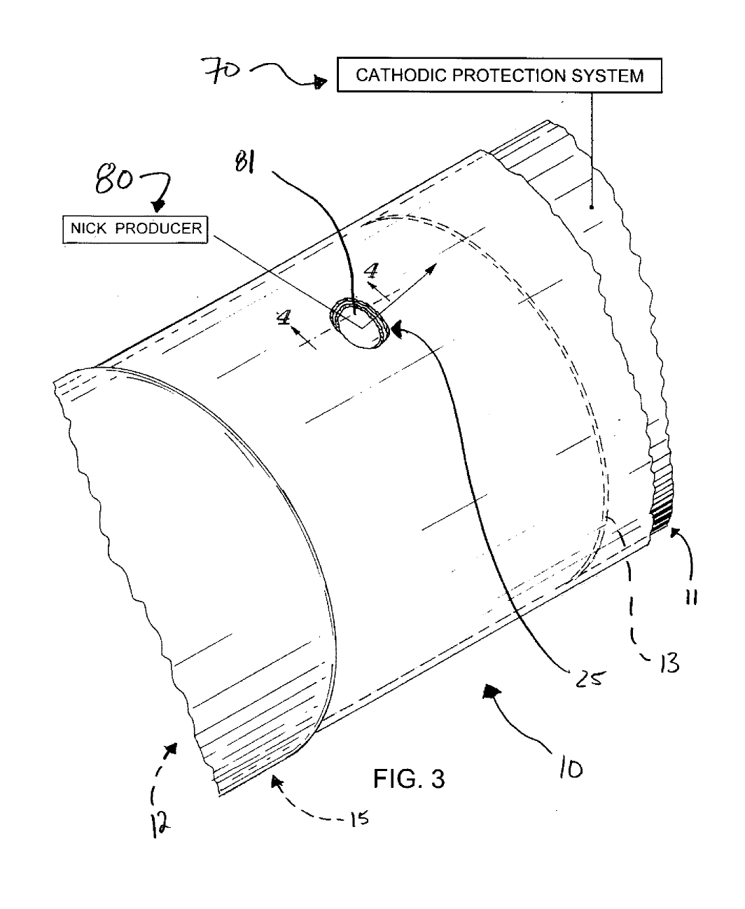

Referring now to FIG. 3, joint-covering sleeve 10 covers second exterior pipe-coating layer 15, the steel pipes, and the butt-weld (all shown in phantom except for that portion of second steel pipe 12 shown extending beyond broken-away joint-covering sleeve 10). Cathodic protection system 70 is connected to the steel pipe. Joint-covering sleeve 10 has been nicked by an external nick producer (shown diagrammatically) to form in the sleeve an aperture (often called a nick or a holiday 81) exposing an exterior surface of underlying steel pipe 12 and interior edges of shrink-wrap material 25 included in joint-covering sleeve 10.

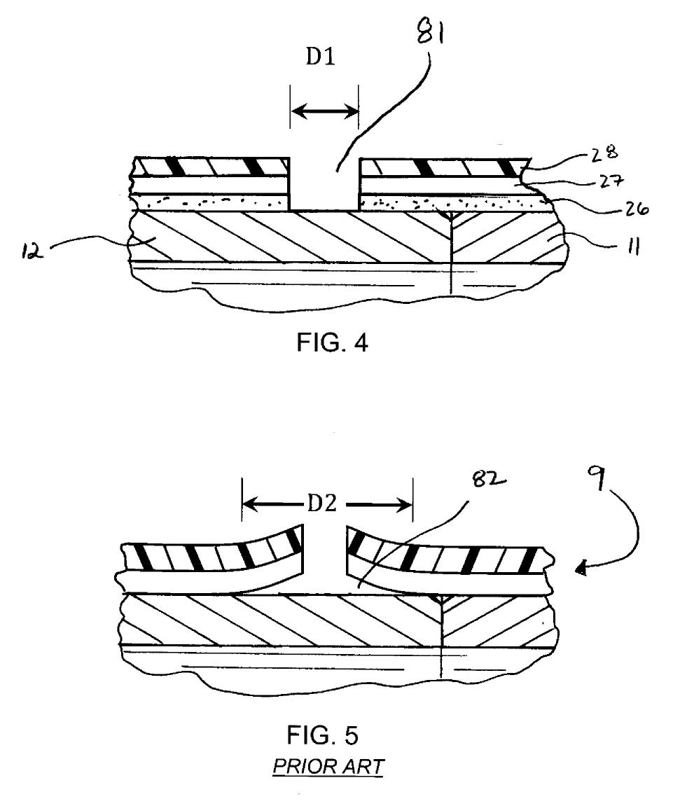

Referring now to FIG. 4, holiday 81 is defined by the aperture formed in joint-covering sleeve 10 is characterized by a dimension D1. Any disbondment (i.e., separation) of joint-covering sleeve 10 from the second steel pipe 12 at holiday 81 is insubstantial. To the contrary, a prior art sleeve 9 shown in FIG. 5 is a sectional view of a pipeline showing disbondment 82 of the sleeve from the pipeline at a holiday formed in the sleeve and showing that disbondment 82 is characterized by a dimension D2.

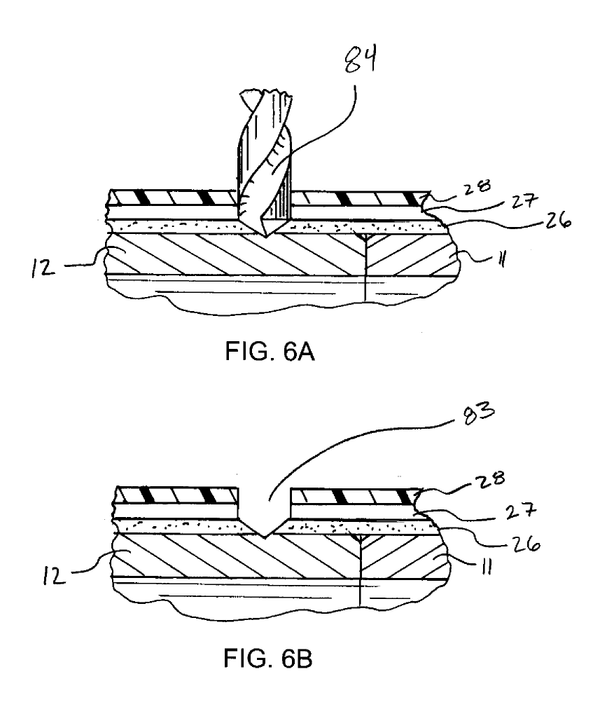

FIG. 6A-B are sectional views of a sleeve on a pipeline showing that sleeves can be tested for resistance to disbondment according to the procedure of ASTM G42. The method of ASTM G42 includes producing a standard-sized holiday 83 in shrink-wrap material with a drill bit 84 (FIG. 6A) and testing disbondment at the resulting holiday after drill bit 84 is removed (FIG. 6B).

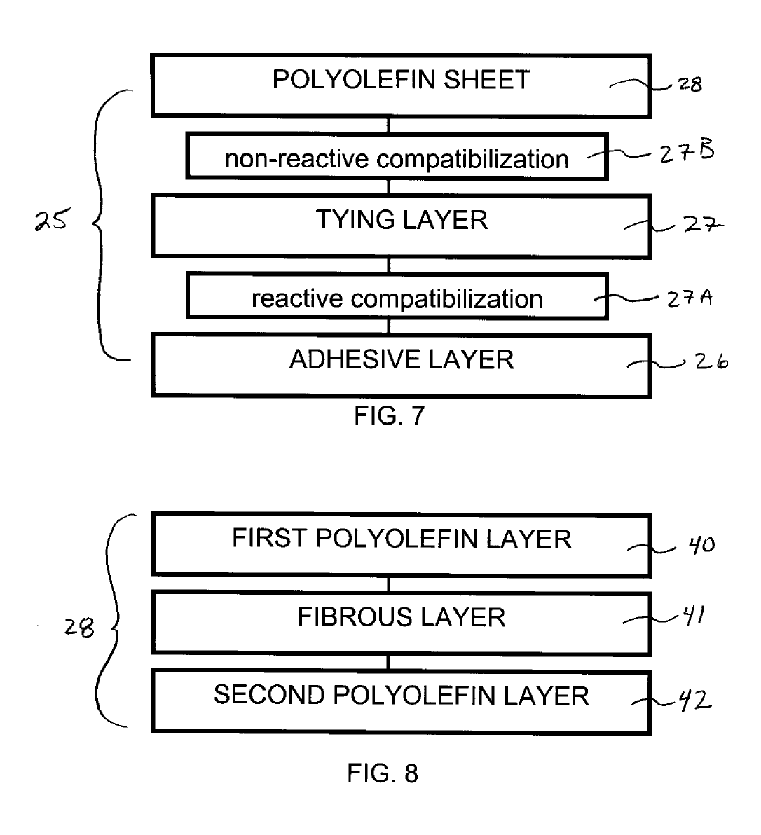

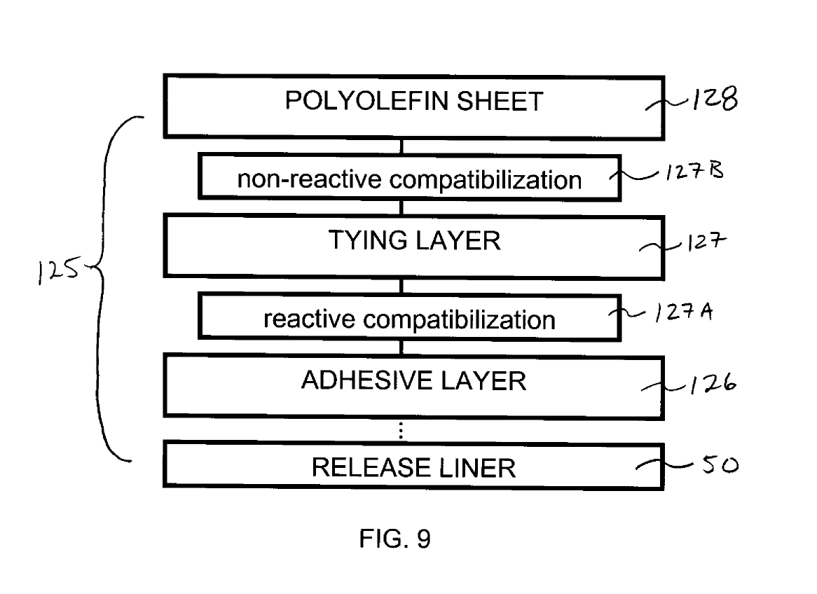

Referring now to FIG. 7, shown is a diagrammatic representation of a first embodiment of shrink-wrap material 25 used to form joint-covering sleeve 10 of FIGS. 1-4. The shrink-wrap material 25 comprises an adhesive layer 26 adapted to be coupled to the pipeline, a polyolefin sheet 28 arranged to provide an exterior skin of joint-covering sleeve 10, and a tying layer 27 interposed between adhesive layer 26 and polyolefin sheet 28. Tying layer 27 is bonded to the adhesive layer using reactive compatibilization 27A and to the polyolefin sheet using non-reactive compatibilization 27B. One embodiment of polyolefin sheet 28 is shown diagrammatically in FIG. 8. Polyolefin sheet 28 comprises a fibrous layer 41 interposed between and in contact with a first polyolefin layer 40 and a second polyolefin layer 42. In another embodiment of a heat-shrinkable coating 125 as shown in FIG. 9, a release liner may be adapted to contact an adhesive layer 126 to block unintended adhesion.

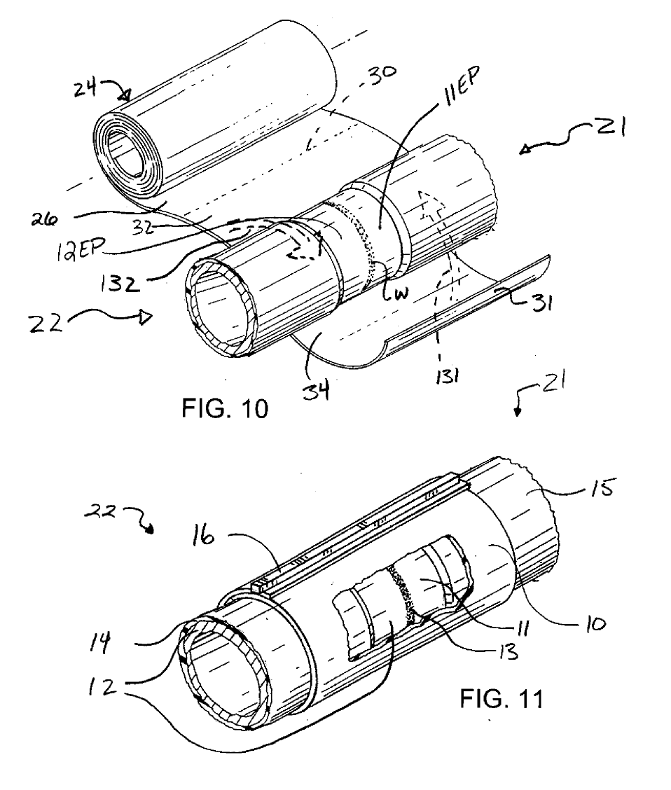

As suggested in FIGS. 10-13, joint-covering sleeve 10 is used as part of a process of joining a first pipe unit 21 including first steel pipe 11 to a second pipe unit 22 including second steel pipe 12. In an illustrative embodiment, first pipe unit 21 includes first exterior pipe-coating layer 14 made of a plastics material and applied to cover an exterior surface of first steel pipe 11 as suggested in FIGS. 1-2. Second pipe unit 22 further includes similar second exterior pipe-coating layer 15 as suggested in FIGS. 1-2.

As suggested in FIG. 10, in a first stage of the pipe-joining process disclosed herein, first pipe unit 21 is coupled to second pipe unit 22 by butt-welding one end of first steel pipe 11 to an opposing end of second steel pipe 12 using a girth weld (W) to establish joint 13. It is within the scope of this disclosure to use any suitable welding technique. In an illustrative embodiment, each of first and second pipe units 21, 22 is configured to include an exposed portion 11EP or 12EP of first and second steel pipes 11, 12 that is not covered with exterior pipe-coating layers 14 or 15.

As further suggested in FIG. 10, in a second stage of the pipe-joining process disclosed herein, a roll 24 of shrink-wrap material 25 is unrolled and cut along cut line 30 to produce joint-covering sleeve 10. In an illustrative embodiment, joint-covering sleeve 10, at this stage, is a rectangular piece of material having a first end portion 31 away from cut line 30, an opposite second end portion 32 along cut line 30, and a web 34 interconnecting first and second end portions 31, 32.

Joint-covering sleeve 10 is first wrapped around an exposed portion 11EP and 12EP of first and second pipe units 21, 22 as suggested in FIG. 3 to cover joint 13 and then retained by sleeve retainer 16 in a stationary position covering joint 13 as suggested in FIG. 11. While web 34 is arranged to underlie joint 13, first end portion 31 is moved in first direction 131 to mate with the underlying portions of exterior pipe coating layers 14 and 15. Then second end portion 32 is moved in second direction 132 to lie in overlapping relation with first end portion 31 as suggested in FIG. 11. Then sleeve retainer 16 is placed on an exterior surface of second end portion 32 as suggested in FIG. 11. Magnetic attraction between sleeve retainer 16 and portions of first and second steel pipes 11, 12 causes sleeve retainer 16 to remain in a stationary position relative to first and second steel pipes 11, 12 trapping first and second end portions 31, 32 of joint-covering sleeve 10 therebetween as suggested in FIG. 11.

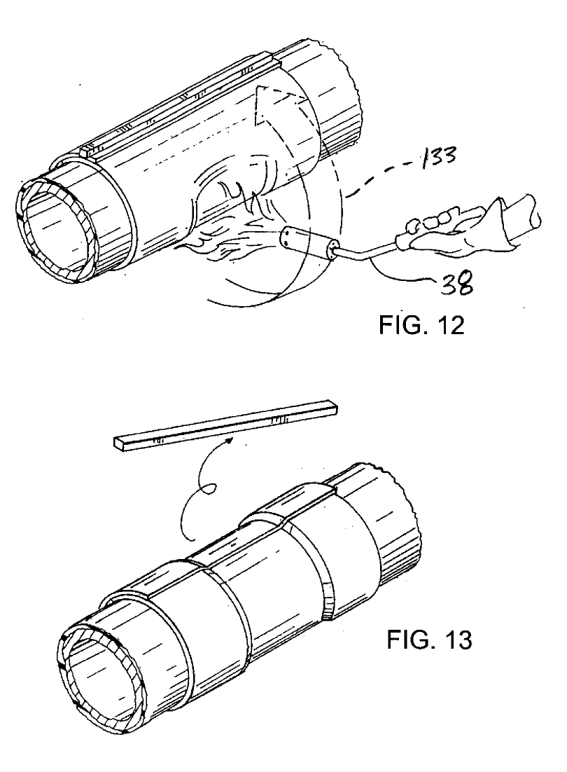

Referring now to FIG. 12, joint-covering sleeve 10 is heated using gas torch 38 or other suitable heater to at least a predetermined temperature to cause shrink-wrap material 25 forming joint-covering sleeve 10 to shrink and conform to exposed portions 11EP and 12EP and exterior pipe-coating layers 14 and 15. Using an illustrative technique suggested in FIG. 12, gas torch 38 is moved around the circumference of joint-covering sleeve 10 in third direction 133 using a side-to-side motion to apply heat to all exposed exterior surfaces of joint-covering sleeve 10 while sleeve retainer 16 is held magnetically in place on second end portion 32 of joint-covering sleeve 10 to cause shrink-wrap material 25 to shrink.

Once joint-covering sleeve 10 has been heated to shrink and conform to exposed portions of first and second pipe units 21, 22 as suggested in FIGS. 12 and 13, sleeve retainer 16 can be removed from joint-covering sleeve 10 by a technician as suggested in FIG. 13. Once shrunk, joint-covering sleeve 10 retains its shape covering joint 13 without use of sleeve retainer 16.

Joint-covering sleeve 10 can be provided as a slip-on sleeve or as a wrap-around sleeve. The wrap-around sleeve is arranged (in a manner suggested, for example, in FIGS. 10-13) to cover joint 13 between two steel pipes that are included in the pipeline. The slip-on sleeve is manufactured in a form that is continuous with a circular configuration. As such, a slip-on sleeve must be slipped onto the either pipe and moved to a position at a predetermined distance from the joint so that a weld can be made. The slip-on sleeve is then moved back over the joint after welding is complete.

In one aspect, joint-covering sleeve 10 exhibits the strength and corrosion protection characteristics of a comparable continuous film, but resists cathodic disbondment due to inclusion of a tying means in tying layer 27. The specifications sufficient to meet the requirements of a given application are strongly influenced by that application. For example, a sleeve appropriate to cover a particular pipe should be matched to the intended use of the pipe. The intended use will establish the physical dimensions of the pipe and composition and structure of any exterior pipe covering that is used to protect the pipe. Depending on the intended use, the exterior pipe coating may include a multi-layer product comprising a fusion bonded epoxy (FBE), a low- or high-density polyethylene coupled with mastics, or any number of other coatings known in the art. The joint-covering sleeve should be selected, to some extent, with a view to compatibility with the exterior pipe coating. The precise construction of the sleeve will depend on the specific application, and the variables to be considered include the following; width of sleeve, shrink ratio of sleeve, size, shape and number of regions of heat-activatable adhesive, thickness of sealant and thickness of adhesive, and the nature of the sealant and of the adhesive. The sleeve conveniently will be produced and supplied in long spooled lengths so that a suitable length can be cut-off, depending on the diameter of pipe to be protected.

In illustrative embodiment, the polyolefin sheet is made from master batches of suitable components including polyolefins, UV stabilizers, colorants, aging stabilizers, and cross-linking additives. In illustrative embodiments, during or after extrusion, the polyolefins are cross-linked through a cross-linking treatment. Typically, cross-linking is carried out through either the inclusion of chemical cross-linking agents or by exposing the polyethylene to radiative cross-linking techniques, such as electron beam (e-beam) irradiation.

In illustrative embodiments, the joint-covering sleeve includes a cross-linked polyolefin sheet, a tying layer, and an adhesive layer. The cross-linked polyolefin sheet is cross-linked so that upon heating, the polyolefin sheet shrinks. The cross-linking may be imparted on the polyolefin through irradiation or the incorporation of chemical cross-linking agents. The adhesive includes compatible mastic, hot-melt, epoxy, polyurethane, or other suitable adhesive materials.

In illustrative embodiments, the polyolefin sheet is heat shrinkable. In one embodiment, the polyolefin sheet shrinks by about 5% to about 200%, based on the reduction in length, upon heating. In another embodiment, the polyolefin sheet shrinks by about 10% to about 60%, based on the reduction in length, upon heating. In yet another embodiment, the polyolefin sheet shrinks by about 25% to about 50%, based on the reduction in length, upon heating. In one embodiment, the polyolefin sheet shrinks from about 10% to about 60%, based on the reduction in length, upon heating. In one embodiment, heating includes raising the temperature of the polyolefin sheet to at least about 60 degrees Celsius. In another embodiment, heating includes raising the temperature of the polyolefin sheet into a range of about 60 degrees Celsius to about 200 degrees Celsius. In yet another embodiment, heating includes raising the temperature of the polyolefin sheet into a range of about 100 degrees Celsius to about 160 degrees Celsius. In one embodiment, the shrink force is greater than about 30 psi, as determined by ASTM D-638 at 150 degrees C. In another embodiment, the shrink force is greater than about 40 psi, as determined by ASTM D-638 at 150 degrees C.

The thickness of the joint-covering sleeve depends on the particular application requirements. In one embodiment, the thickness of the joint-covering sleeve is from about 10 to about 100 mils. In another embodiment, the thickness of the joint-covering sleeve is from about 15 to about 80 mils. The thickness of the joint-covering sleeve is strongly influenced by the thickness of the polyethylene sheet. As with the joint-covering sleeve generally, the thickness of the polyethylene sheet is highly dependent on the particular application requirements. In one embodiment, the thickness of the polyethylene sheet is from about 3 to about 50 mils. In another embodiment, the thickness of the polyethylene sheet is from about 10 to about 30 mils

As used herein, the term polyolefin is used generally to describe a polymer produced from a simple olefin, such as an alkene, with the general formula CₙH₂ₙ, as a monomer. Polyolefin includes polyethylene and polypropylene and blends thereof. As used herein, the polypropylene (PP) includes polymers with various molecular weights, densities, and tacticities synthesized from propylene monomers. Polyethylene (PE) includes polymers made through a polymerization of ethylene. For example, PE may include those polymers of ethylene polymerized through a free-radical polymerization. For example, PE may have a high degree of short and long chain branching. PE also includes copolymers of ethylene and an alpha-olefin comonomer made through a single site catalyzed reaction (e.g., through a metallocene catalyzed reaction) or a blend thereof with an elastomer or high pressure low density polyethylene. The polyolefin may also include ethylene/ethyl acrylate copolymers, ethylene/acrylic acid copolymers, or ethylene/vinyl acid copolymers, fluoropolymers such as polyvinylidene fluoride or ethylene/tetrafluoroethylene copolymer, nylon, or elastomers.

PE includes copolymers made with various alpha olefin monomers including 1-butene, 3-methyl-1l-butene, 3-methyl-1-pentene, 1-hexene, 4-methyl-1-pentene, 3-methyl-1-hexene, 1-octene or 1-decene. For example, the alpha olefin comonomer may be incorporated from about 1% to about 20% by weight of the total weight of the polymer, preferably from about 1% to about 10% by weight of the total weight of the polymer. While specific polymer compositions are referred to herein, polymers or polymer blends with substantially equivalent physical properties could be substituted, yet remain within the scope of the present disclosure. In particular, those polymers having substantially equivalent melt indexes (MI) and flow ratios (FR) may be particularly suitable. MI (units herein of g/10 min) is an indication of molecular weight, wherein higher MI values typically correspond to low molecular weights. At the same time, MI is a measure of a melted polymer's ability to flow under pressure. FR is used as an indication of the manner in which rheological behavior is influenced by the molecular weight distribution of the material.

In illustrative embodiments, the polyolefin sheet is extruded or otherwise melt-shaped. The thickness of the element is dependent on the size of the substrate and the strength required by the article in its recovered state. Following extrusion (or in the case of chemical cross-linking, during extrusion), the polymeric element is cross-linked by radiation or chemical means. The element is then expanded or otherwise deformed from its original extruded shape. In one embodiment, the expansion is conducted at a temperature above the melting point of the polymer. It may be unidirectional or multidirectional, depending on the final product. Expansion of polymeric sheet is often conducted by heating the sheet, passing it over heated rollers, and stretching it. The stretched sheet is then cooled by passing it around cold rollers. In illustrative embodiments, the expanded sheet has a thickness of from 50% to 85% of the thickness of the unexpanded sheet.

The polyolefin sheet may include one or more fibrous layers. In one embodiment, the fibrous layer is comprised of polyolefin fibers woven into a weave such that the layer exhibits a non-continuous dielectric resistance. As used herein, a fiber is the basic element of a fabric having a length at least 100 times its diameter or width which can be made into a fabric. The term fiber is not limited to a particular geometric cross-section, but instead includes all fiber cross-sections currently known in the art or discovered thereafter. For example, the term fiber includes those fibers having a circular or rectangular cross section. The term fiber includes monofilament fibers or yarns which include fibers made of two or many filaments. In one embodiment, the weave is selected from a group consisting of plain weave, satin weave, twill weave, basket weave, jacquard weave, rib weave, dobby weave, leno weave, and oxford weave. In another embodiment, the denier of the polyolefin fiber is in the range from about 200 to about 4000 denier. As used herein, the term denier is a unit of measure for the linear mass density of fibers. It is defined as the mass in grams per 9,000 meters of the fiber.

The adhesive layer comprises one or more adhesives. The adhesive may be referred to as an anti-corrosion adhesive because it prevents the penetration of liquids (for example, alkaline or acidic water), gases (for example, air and water vapor), microbes and fungi to the surface of the substrate (for example, pipe). The adhesive is in contact with the tying layer which is in contact with the polyolefin sheet. The heat-shrink may be applied to a substrate by arranging the coating so that the adhesive contacts the substrate. The polyolefin sheet is conformable to the shape of the substrate and the adhesive layer provides adhesion between the substrate and the tying layer.

As used herein, the adhesive layer comprises those materials known in the art as adhesives. For example, mastic, hot-melt, polyurethane, polyimide, synthetic rubber, and epoxy adhesives may be used. One aspect of the present disclosure is that the adhesive layer assures long-term bonding of the polyolefin sheet to the pipe or substrate, and provides principal corrosion resistance and added mechanical strength to the coating.

In illustrative embodiments, the adhesive is a hot-melt adhesive. For example, the hot-melt adhesive may include one as disclosed in U.S. Pat. Nos. 4,181,775, 4,018,733, or 4,359,556, which references are herein incorporated by reference for disclosure related to adhesive compositions. Exemplary adhesives include polyamides modified with hydrocarbon waxes and mixtures of acidic ethylene polymers polyamides and tackifiers. Further exemplary adhesives include EVA compositions including hydrocarbon waxes and butyl rubber. In one embodiment, the adhesive includes a polyamide and between 0.25 to 10% by weight of an acrylic rubber. In another embodiment, the adhesive includes a polyamide and 10 to 20% ethylene/acrylic terpolymer, based on the weight of the polyamide. Exemplary terpolymers include ethylene, an ethylenically unsaturated mono- or di-carboxylic acid, and a vinyl ester of a C₁-C₆ straight or branched chain aliphatic carboxylic acid. In one embodiment, the adhesive includes a polyamide and a ethylene/acrylic acid/butyl acrylate terpolymer. In still other embodiments, the adhesive includes a copolymer of ethylene and a C₂-C₂₀ aliphatic ester of a monoethylenically unsaturated mono- or di-carboxylic acid, or a copolymer of ethylene and vinyl acetate.

In illustrative embodiments, the polyamides have a number average molecular weight of 2000-10000 g/mol, a softening point of 90-150° C., and an amine equivalent of from 70-400 (amine equivalent being the number of milliequivalents of perchloric acid required to neutralize one kilogram of the polyamide). In one embodiment, the polyamides are based on dibasic acids. Illustratively, the polyamide is based on dimer acids with less than about 10% by weight of the total acid component of the polyamide being tribasic and/or higher acids. In one embodiment, the polyamide is a condensation interpolymers of at least one diamine with one or more dibasic acids. In one embodiment, the polyamide has a glass transition temperature below 10° C. In another embodiment, the adhesive may further comprise a liquid polyamide.

In illustrative embodiments, the temperature at which the polyolefin sheet shrinks and the adhesive material activates are compatible so that the heating of the joint-covering sleeve causes the polyolefinic sheet to shrink and the adhesive to activate simultaneously. In one embodiment, the sleeve can be coated with a temperature indicating composition to give the worker an indication when sufficient heat has been applied. In one embodiment, the temperature at which the polyolefin sheet shrinks and the adhesive is activated is in the range of 90-150° C. In another embodiment, the temperature at which the polyolefin sheet shrinks and the adhesive is activated is in the range of 110-135° C. These ranges may be appropriate for joint-covering sleeves that are used in applications with operating temperature in the range of −30 to 70° C. In another embodiment, the adhesive composition includes a non-reversible hot melt adhesive. That is, the term hot-melt adhesive includes those adhesives which crosslink to form thermoset polymers upon heat activation.

In one embodiment, at least one adhesive has a softening point of greater than 50° C., as determined by ASTM E-28. In another embodiment, at least one adhesive has a softening point of greater than 80° C., as determined by ASTM E-28. In yet another embodiment, at least one adhesive has a softening point of greater than 100° C., as determined by ASTM E-28. In one embodiment, at least one adhesive has a peel to steel of greater than 10 lbs/in. width, as determined by ASTM D-1000. In another embodiment, at least one adhesive has a peel to steel of greater than 15 lbs/in. width, as determined by ASTM D-1000. In yet another embodiment, at least one adhesive has a peel to steel of greater than 20 lbs/in. width, as determined by ASTM D-1000. In one embodiment, at least one adhesive has an impact resistance of greater than 20 in-lbs, as determined by ASTM G-14. In another embodiment, at least one adhesive has an impact resistance of greater than 30 in-lbs, as determined by ASTM G-14. In yet another embodiment, at least one adhesive has an impact resistance of greater than 40 in-lbs, as determined by ASTM G-14. In one embodiment, at least one adhesive has a penetration resistance of less than about 20%, as determined by ASTM G-17. In another embodiment, at least one adhesive has a penetration resistance of less than about 15%, as determined by ASTM G-17. In yet another embodiment, at least one adhesive has a penetration resistance of less than about 10%, as determined by ASTM G-17.

In illustrative embodiments of the present disclosure, the joint-covering sleeve of the present disclosure includes a tying layer. The tying layer is interposed between and in contact with the adhesive layer and the polyolefin sheet. The tying layer interacts with the adhesive layer through reactive compatibilization and with the polyolefin sheet through non-reactive compatibilization.

In illustrative embodiments, the joint-covering sleeve comprises a tying layer. In one embodiment, the tying layer is interposed between and in contact with the heat-shrinkable polyolefin sheet and the adhesive layer and the tying layer includes tying means for coupling the heat-shrinkable polyolefin sheet to the adhesive layer to retain the heat-shrinkable polyolefin sheet and the adhesive layer on the pipe and to minimize disbondment during aging. In one embodiment, the tying means includes blending an amount of a reactively-modified polyolefin in the tying layer to provide adhesion to the polyolefin sheet and reactivity towards the adhesive layer so that contacting the adhesive layer to the tying layer creates covalent bonds between components of each layer. According to one aspect of the disclosure, the formation of covalent bonds between the adhesive layer and the covalent layer is referred to reactive compatibilization.

As used herein, reactive compatibilization describes the methods, techniques, and compounds used to combine highly immiscible polymers into blends to create useful compositions with good mechanical compatibility. In illustrative embodiments, reactive compatibilization involves the introduction of a reactive moiety onto a polymer chain identical or similar to one blend component capable of reacting with another polymeric component. In one embodiment, the introduction of a reactive site onto a polymer results in a graft copolymer. In another embodiment, the graft copolymer will concentrate at the interface between two immiscible polymeric materials and reduce the interfacial tension. The concentration at the interface provides improved dispersion, domain size reduction, and improved mechanical properties over the binary blend. In another embodiment, reactive compatibilization includes the addition of a polymer miscible with one component capable of reacting with the other component to form a graft copolymer. For example, a polystyrene (PS) copolymer containing minor amounts of maleic anhydride (MA) blended with poly(phenylene oxide) (PPO)/polyamide 6 (PA6 or Nylon 6). The resultant PS-g-PA6 copolymer will concentrate at the interface as the PS chains prefer to be in the PPO phase.

In illustrative embodiments, reactive compatibilization includes using maleic anhydride grafted onto polyolefins. In further illustrative embodiments, maleic anhydride is used as a comonomer in polystyrene copolymers and terpolymers. Maleic anhydride can react with the amine end groups of polyamides as well as the hydroxyl end groups of polyesters to provide the desired graft copolymer useful for compatibilization. Acrylic acid can be used as grafts or in copolymers to provide similar tying means. In one embodiment, oxazoline functionalized polymers reacts with either amine or carboxylic acid end groups of polyamides or acid end groups of polyesters to provide tying means. In another embodiment, isocyanate groups grafted to polyolefins or used as comonomers can react with amines, carboxylic acids, or hydroxyl containing polymers. In another embodiment, an epoxy group, incorporated into a polymer through copolymerization, for example glycidyl methacrylate (GMA), or grafted to a polyolefin can react with amine, carboxylic acid, or even with hydroxyl containing polymers.

In illustrative embodiments, the reactive moiety may be grafted onto polyolefins or unsaturated polymers by free radical grafting techniques employing a peroxide. In one embodiment, GMA is grafted onto PP or PE using a free radical reaction. In another embodiment, MA is grafted onto a SBS block copolymer, a PP, or a PE, or blend thereof using a free-radical grafting reaction.

In illustrative embodiments, the tying layer includes a maleic anhydride reactively modified polyolefin. In one embodiment, the maleic anhydride is grafted onto the polyolefin to compatibilize polyamides of the adhesive layer and polyolefins of the polyolefin sheet. One aspect of the present disclosure is that the tying layer provides reactivity between the reactively modified polyolefin and a polyamide in the adhesive layer while provide enhance miscibility and dispersibility between the polyolefin sheet and the adhesive layer. In one embodiment, the tying layer provides blending between the polyolefin sheet and the adhesive layer so that a well-defined laminar structure is no longer apparent. Instead, the tying layer provides that a compositional gradient may be evident beginning in the polyolefinic sheet where the polyolefinic sheet is at first primarily polyolefinic in nature and ending in the adhesive layer which is predominantly devoid of a polyolefin. Between these two locations, a compositional gradient may be evident so that the composition changes from predominantly polyolefinic to predominantly non-polyolefinic according to a continuous function.

In one aspect of the present disclosure, the tying layer may be described as a blends of adhesive layer components (e.g. polyamides) with polyolefin sheet components (e.g. polyethylene), wherein the reactively modified polymer (e.g. MA grafted onto polyethylene using a free-radical extrusion grafting) compatibilizes the components by lowering surface tension, enhancing miscibility, enhancing dispersibility, and reacting with components from the adhesive layer. Another aspect of the present disclosure is that providing reactive compatibilization results in significant improvements in mechanical properties for a joint-covering sleeve compared to the sleeves which do not include compatibilization.

It should be pointed out that the relationship between the tying layer and the polyolefinic sheet is described as non-reactive compatibilization. As used herein, this term is intended to convey that while the tying layer does compatibilize the polyolefinic layer and the adhesive layer, the tying layer, as disclosed herein, reactivity between the tying layer and the polyolefinic sheet is not required. Instead, the graft co-polymer is miscible in the polyolefinic sheet without forming covalent bonds. For example, a first polyolefin is generally miscible in another polyolefin even if the first polyolefin has been reactively modified to include a reactive moiety.

One aspect of the present disclosure is that the presence of the tying layer provides joint-covering sleeves described herein with enhanced physical properties. In an illustrative embodiment, one enhanced physical properties is a resistance to disbondment. A resistance to disbondment was determined by testing joint-covering sleeves, as described herein, under accelerated aging conditions, specifically cathodic disbondment according to ASTM test methods. Accordingly, the present disclosure describes the enhanced adhesion characteristics of a thermoplastic polyamide hot melt when bonded to a heat-shrinkable polyolefin film by means of reactive compatibilization. Prior art polyamide hot melt adhesives degrade and lose adhesion to the polyolefin as they age. This effect is accelerated at elevated temperatures. The tying layer prevents this loss of adhesion as it bonds effectively to the heat-shrinkable polyolefin film while the reactive moiety (e.g. maleic anhydride) reacts with the amino groups of the hot melt polyamide adhesive, making the bond durable. Another aspect of the present disclosure is that the reactive compatibilization does not adversely affect the polyamide adhesion bond to a liquid coating (e.g. epoxy coating), that may be used on the pipe.

Cathodic disbondment was tested according to ASTM G 42-96 (Reapproved 2003) (herein referred to as “ASTM G 42”). ASTM G 42 is an accelerated corrosion test that is useful for comparing coatings applied to pipes. Specifically, the procedure is a laboratory tool used to measure the ability of a coating to protect a pipe from corrosion simulating those conditions the pipe and coating may be subjected to in an underground installation. The test simulates a high temperature electrolytic environment in which the pipe would be under cathodic protection. The accelerated underground installation is simulated in the laboratory by using a conductive electrolyte solution and elevated temperatures (50° C.). For testing under the method, the coating must provide electrical insulation to the pipe. However, an amount of electrical insulation provided by both woven and non-woven polyolefin sheets provides sufficient electrical insulation for application of the G 42 testing procedure.

To simulate a breach or break in the coating a hole is made in the coating to expose the pipe. Breaches, breaks, cuts, and snags are kinds of damage a coating may experience as it is being installed or thereafter. These breaches may result from rocks around the installation and/or other soil conditions. As used herein, the term holiday is a coating location in which damage has occurred. This term is a term of art which means that at least the polyolefin sheet has been pierced. In addition to the piercing of the polyolefin sheet, holidays often include damage to the adhesive layer such that the underlying substrate (e.g. pipe) is exposed. When the term holiday is used with polyolefin sheets that contain fibrous layers, the term means that the fibers have been either broken or separated to the extent that the void space is at least two times greater than the ordinary void space between fibers for that particular woven polyolefin.

According to the ASTM G 42 procedure, electrical stress is provided by placing the specimen in a circuit mirroring that of the cathodic protection system. The current flowing through the system can be measured during the test. The test was designed so that the applied electrical stress causes cathodic disbondment of the coating from the pipe. Cathodic disbondment is characterized by a loosening of the coating in the region of the holiday. In coatings made according to methods within the prior art, cathodic disbondment may include a loss of adhesion between the pipe and the adhesive layer or a loss of adhesion between the adhesive layer and the polyolefin sheet. Cathodic disbondment of an embodiment of the present disclosure would included a loss of adhesion between the adhesive layer and the pipe, a loss of adhesion between the adhesive layer and the tying layer, or a loss of adhesion between the tying layer and the polyolefin sheet.

The region surrounding the holiday exhibits disbondment first and is characterized as the loosening of the coating between the pipe and the coating. The cathodic disbondment exposes additional portions of the pipe to the electrolyte solution which, in the field, would expose greater portions of the pipe to corrosion. The disbondment would thus require more from the cathodic protection system and lead to increased corrosion. The results from the ASTM test are in the form of a physical evaluation of the disbondment site (surrounding the hole) and the amount of current drawn during the testing. The performance of a given coating can be compared to others by comparing the size of the disbondment site. It is desirable that the disbondment site remain comparatively small although the conditions of the test are designed to elicit some disbondment even in well-bonded coatings.

In illustrative embodiments, a joint-covering sleeve for covering an outer surface of a pipe comprises a heat-shrinkable polyolefin sheet, a tying layer, and an adhesive layer. The tying layer is interposed between and in contact with the heat-shrinkable polyolefin sheet and the adhesive layer. The tying layer includes tying means for coupling the heat-shrinkable polyolefin sheet to the adhesive layer to retain the heat-shrinkable polyolefin sheet and the adhesive layer on the pipe and to minimize disbondment during aging. In another embodiment, the tying means includes blending an amount of a reactively-modified polyolefin in the tying layer to provide miscibility with the polyolefin sheet and reactivity towards the adhesive layer so that contacting the adhesive layer to the tying layer creates covalent bonds between components of each layer. In one embodiment, tying means minimizes disbondment for a pipe with cathodic protection. In another embodiment, tying means minimizes disbondment tested according to the procedure set forth in ASTM G42. In another embodiment, the adhesive layer comprises an adhesive selected from a group consisting of mastics, polyurethanes, polyamides, synthetic rubbers, and epoxies. In yet another embodiment, the heat-shrinkable polyolefin sheet comprises an irradiation cross-linked polyethylene, polypropylene, or blend thereof and the adhesive layer comprises a polyamide. In another embodiment, contact between the tying layer and the adhesive layer includes the reactively-modified polyolefin covalently reacting to the polyamide.

In illustrative embodiments, the heat-shrinkable polyolefin sheet, the tying layer, and the adhesive layer are combined to provide the coating with a peel adhesion to primer as determined according to EN12068 of greater than about 50 N/cm initially and throughout a period of aging at 80° C. for 100 days. European Standard EN12068 describes the standard testing procedure for the evaluation of external organic coatings for the corrosion protection of buried or immersed steel pipelines used in conjunction with cathodic protection as in relates to tapes and shrinkable materials, the disclosure of which is herein incorporated by reference in its entirety.

In one embodiment, the heat-shrinkable polyolefin sheet shrinks by about 10% to about 60%, based on circumferential length, in response to being heated to at least about 60° C. In another embodiment, the heat-shrinkable polyolefin sheet, the tying layer, and the adhesive layer are combined to minimize disbondment according to ASTM G42. In another embodiment, the heat-shrinkable polyolefin sheet comprises an irradiation cross-linked polyethylene, polypropylene or blend thereof providing about 10% to about 60% shrinkage, based on circumferential length, in response to being heated to at least about 60° C., the adhesive layer comprises a polyamide, contact between the tying layer, and the adhesive layer is characterized by the reactively-modified polyolefin covalently bonding with the polyamide to provide the coating with a peel adhesion to primer as determined according to EN12068 of greater than about 50 N/cm initially and throughout a period of aging at 80° C. for 100 days. In another embodiment, the heat-shrinkable polyolefin sheet comprises a woven heat-shrinkable polyolefin sheet. In another embodiment, the coating further comprises an epoxy adhesive layer. In one embodiment, the epoxy adhesive layer is in contact with the adhesive layer on a surface of the adhesive layer opposite of the tying layer, forming in series, the heat-shrinkable polyolefin sheet, the tying layer, the adhesive layer, and the epoxy adhesive layer.

In illustrative embodiments, the heat-shrinkable polyolefin comprises an irradiation cross-linked polyethylene, polypropylene, or blend thereof, the adhesive layer comprises a polyamide, and the tying layer comprises a reactively-modified polyolefin, the reactively-modified polyolefin providing adhesion to the heat-shrinkable polyolefin sheet and covalently bonding with the polyamide. In one embodiment, the joint-covering sleeve further comprises a release liner, the release liner in contact with the adhesive layer, forming in series, the heat-shrinkable polyolefin sheet, the tying layer, the adhesive layer, and the release liner. In another embodiment, the joint-joint covering sleeve further comprises an epoxy adhesive layer and a release liner, wherein the epoxy adhesive layer is interposed between and in contact with the adhesive layer and the release liner forming in series the heat-shrinkable polyolefin sheet, the tying layer, the adhesive layer, the epoxy adhesive layer, and the release liner, the heat-shrinkable polyolefin sheet comprising an irradiation cross-linked polyethylene, the adhesive layer comprising a polyamide, the tying layer comprising a reactively-modified polyolefin providing adhesion to the heat-shrinkable polyolefin sheet and covalent bonding with the polyamide of the adhesive layer.

In illustrative embodiments, a joint-covering sleeve comprises an adhesive layer in contact with a tying layer and the tying layer in contact with a heat-shrinkable polyolefin backing, forming in series, the adhesive layer, the tying layer, and the heat-shrinkable polyolefin backing, wherein the tying layer adheres to the heat shrinkable polyolefin backing through non-reactive compatibilization that includes at least polymer chain entanglements provided by miscibility and van der Waals interactions and the tying layer bonds to the adhesive layer through at least covalent bonds formed between at least one component of the tying layer and at least one component of the adhesive layer, the adhesive layer, the tying layer, and the heat-shrinkable polyolefin sheet arranged and combined to minimize disbondment according to ASTM G 42. In one embodiment, the adhesive layer comprises an adhesive selected from a group consisting of mastics, polyurethanes, polyamides, synthetic rubbers, and epoxies. In another embodiment, the heat-shrinkable polyolefin backing comprises a polyolefin selected from a group consisting of polyethylene, polypropylene, and blends thereof. In another embodiment, the heat-shrinkable polyolefin sheet, the tying layer, and the adhesive layer are adapted to cover the pipe upon shrinking to seal substantially the pipe from water and water vapors without sealing the pipe from passage of current.

In illustrative embodiments, a joint-covering sleeve is produced by extrusion as a flat strip; however, tubular extrusion and cutting is an alternative within the scope of the present disclosure. In one embodiment, the cross-linking and expansion steps are carried out as part of the same extrusion process. In another embodiment, the coating operation, wherein the adhesive is provided to contact the polyolefin sheet, is part of the same production line. As described herein, a removable release liner or paper can be applied to the adhesive layer as necessary to prevent unintended adhesion.

### EXAMPLES

The disclosure will be further described in connection with the following examples, which are set forth for purposes of illustration only.

Referring now to Table 1, shown are the results comparing a joint-covering sleeve in accordance with the present disclosure (Example 1) tested along with a sleeve of the prior art (Comparative Example). Example 1 included a polyolefin sheet comprising a first and second polyethylene layer with a polyethylene wove layer interposed between the polyethylene layers. The structure of the polyolefin layer shown in FIG. 8. The polyolefin sheet further comprised ethylene vinyl acetate copolymers and terpolymers and carbon black. Example 1 further included a maleic anhydride modified polyethylene (low density & liner low density polyethylene) in the tying layer. As an adhesive, Example 1 included a hot-melt thermoplastic polyamide (composition addressed in U.S. Pat. No. 4,359,556. Furthermore, a coating layer was used on the pipe comprising an epoxy liquid coating. The comparative example was made with an identical construction except that no tying layer was incorporated.

TABLE 1

| | Test | | | Comparative | |
|---|---|---|---|---|---|
| Property | Method | Test Conditions | Requirements | Example | Example 1 |
| Peel adhesion to | EN12068 | 23° C. | 10 N/cm min | 158.2 | >200 N/cm |
| primer | | CHS-10 mm/min | | 100% CF | Backing breaks |
| | | 50° C. | 1 N/cm min | 29.1 | 40.3 |
| | | CHS-10 mm/min | | 100% CF | 100% CF |
| Peel adhesion to | EN12068 | 23° C. | 10 N/cm min | NT | >200 N/cm |
| primer | | CHS-10 mm/min | | | Backing breaks |
| After 25 days heat | | 50° C. | 1 N/cm min | 42.6 | 98.1 |
| aging @ 80° C. | | CHS-10 mm/min | | 100% CF | 100% CF |
| Peel adhesion to | EN12068 | 23° C. | 10 N/cm min | NT | >200 N/cm |
| primer | | CHS-10 mm/min | | | Backing breaks |
| after 50 days heat | | 50° C. | 1 N/cm min | 42.07 | 86.9 |
| aging @ 80° C. | | CHS-10 mm/min | | 100% CF | 100% CF |
| Peel adhesion to | EN12068 | 23° C. | 10 N/cm min | NT | >200 N/cm |
| primer | | CHS-10 mm/min | | | Backing breaks |
| after 70 days heat | | 50° C. | 1 N/cm min | 46.1 | 83.3 |
| aging @ 80° C. | | CHS-10 mm/min | | 100% CF | 100% CF |
| Peel adhesion to | EN12068 | 23° C. | 10 N/cm min | NT | >200 N/cm |
| primer | | CHS-10 mm/min | | | Backing breaks |
| After 100 days heat | | 50° C. | 1 N/cm min | 40.2 | 78.5 |
| aging @ 80° C. | | CHS-10 mm/min | | 100% CF | 100% CF |
| | | | | % retention | % retention |
| | | | P100/0 ≧ 0.75 | 100/0-1.38% | 100/0-1.95% |
| | | | P100/70 ≧ 0.80 | 100/70-0.87% | 100/70-0.95% |
| Cathodic | ASTM G42 | 30 days | 10 mm Max | 9.8 | 5.8 |
| Disbondment | | 50° C. | | | |
| Test on prime | | | | | |
| pipes | | | | | |
| Hot Water | Covalence | 30 days | No blisters, water | Pass all | Pass all |
| Immersion | Test | 60 days | ingress or signs | 4 months | 4 months |
| Test on prime | Method | 90 days | of corrosion | | |
| pipes | | 120 days | | | |
| Indentation | EN12068 | Class C | 0.6 mm | 2.8 mm | 2.9 mm |
| Resistance on | | 72 hours @ 60° C. | remaining | Pass | Pass |
| prime pipes | | | No holidays | | |

Table 1 shows the results of testing each Example. It is first noted that peel adhesion to primer, tested in accordance with EN12068 shows that peel adhesion is greater for Example 1, as compared to the comparative example. Specifically, Table 1 shows that under the 50° C. testing condition, the inclusion of the tying layer provides an enhancement of 38% over the comparative example. After 25 days of aging and under the 50° C. testing condition, the inclusion of the tying layer provides an enhancement of 130% over the comparative example. As can be seen from Table 1, the enhancement is evident across the range of time tested according to EN12068. The cathodic disbondment, tested according to ASTM G42 test result shown in Table 1 also indicate enhanced performance for Example 1 containing the tying layer. Specifically, the disbondment is diminished in size by 41%. The additional analytical results show that the comparative example and Example 1 perform equivalently in other respects. This data affirms that the tying layer does not result in a diminution of other properties for the benefit of peel adhesion and resistance to cathodic disbondment.

What is claimed is:

1. A heat-shrinkable coating for covering an outer surface of a pipe, the coating comprising
a heat-shrinkable polyolefin sheet,
a tying layer, and
an adhesive layer, wherein the tying layer is interposed between and in contact with the heat-shrinkable polyolefin sheet and the adhesive layer and the tying layer includes tying means for coupling the heat-shrinkable polyolefin sheet to the adhesive layer to retain the heat-shrinkable polyolefin sheet and the adhesive layer on the pipe and to minimize disbondment during aging.

2. The coating of claim 1, wherein tying means includes an amount of a reactively-modified polyolefin in the tying layer sufficient to provide adhesion to the polyolefin sheet and reactivity towards the adhesive layer so that contacting the adhesive layer to the tying layer creates covalent bonds between components of each layer.

3. The coating of claim 2, wherein tying means minimizes disbondment for a pipe with cathodic protection tested according to the procedure set forth in ASTM G42.

4. The coating of claim 2, wherein the adhesive layer comprises an adhesive selected from a group consisting of mastics, polyurethanes, polyamides, synthetic rubbers, and epoxies.

5. The coating of claim 2, wherein the heat-shrinkable polyolefin sheet comprises an irradiation cross-linked polyethylene, polypropylene or blend thereof and the adhesive layer comprises a polyamide and wherein contact between the tying layer and the adhesive layer includes the reactively-modified polyolefin covalently bound to the polyamide.

6. The coating of claim 2, wherein the heat-shrinkable polyolefin sheet shrinks by about 10% to about 60%, based on circumferential length, in response to being heated to at least about 60° C.

7. The coating of claim 2, wherein the heat-shrinkable polyolefin sheet, the tying layer, and the adhesive layer are combined to minimize disbondment according to ASTM G42.

8. The coating of claim 2, wherein
the heat-shrinkable polyolefin sheet comprises an irradiation cross-linked polyethylene, polypropylene or blend thereof providing about 10% to about 60% shrinkage, based on circumferential length, in response to being heated to at least about 60° C., the adhesive layer comprises a polyamide, and contact between the tying layer and the adhesive layer is characterized by the reactively-modified polyolefin covalently bonding with the polyamide to provide the coating with a peel adhesion to primer as determined according to EN12068 of greater than about 50 N/cm initially and throughout a period of aging at 80° C. for 100 days.

9. The coating of claim 8, wherein the heat-shrinkable polyolefin sheet is a woven heat-shrinkable polyolefin sheet.

10. The coating of claim 9 further comprising an epoxy adhesive layer, wherein the epoxy adhesive layer is in contact with the adhesive layer on a surface of the adhesive layer opposite of the tying layer, forming in series, the heat-shrinkable polyolefin sheet, the tying layer, the adhesive layer, and the epoxy adhesive layer.

11. The coating of claim 1, wherein the heat-shrinkable polyolefin comprises an irradiation cross-linked polyethylene, polypropylene or blend thereof, the adhesive layer comprises a polyamide, and the tying layer comprises a reactively-modified polyolefin, the reactively-modified polyolefin providing adhesion to the heat-shrinkable polyolefin sheet and covalently bonding with the polyamide.

12. The coating of claim 11, further comprising a release liner, the release liner in contact with the adhesive layer, forming in series, the heat-shrinkable polyolefin sheet, the tying layer, the adhesive layer, and the release liner.

13. The coating of claim 1, further comprising
an epoxy adhesive layer and
a release liner, wherein
the epoxy adhesive layer is interposed between and in contact with the adhesive layer and the release liner forming in series the heat-shrinkable polyolefin sheet, the tying layer, the adhesive layer, the epoxy adhesive layer and the release liner,
the heat-shrinkable polyolefin sheet comprises an irradiation cross-linked polyethylene,
the adhesive layer comprises a polyamide, and
the tying layer comprises a reactively-modified polyolefin providing adhesion to the heat-shrinkable polyolefin sheet and covalent bonding with the polyamide of the adhesive layer.

14. The coating of claim 13, wherein the heat-shrinkable polyolefin sheet shrinks by about 10% to about 60%, based on circumferential length, in response to being heated to at least about 60° C.

15. An apparatus for covering a pipe, the apparatus comprising
an adhesive layer in contact with a tying layer and the tying layer in contact with a heat-shrinkable polyolefin backing, forming in series, the adhesive layer, the tying layer, and the heat-shrinkable polyolefin backing, wherein
the tying layer adheres to the heat shrinkable polyolefin backing through at least polymer chain entanglements and van der Waals interactions and the tying layer bonds to the adhesive layer through at least covalent bonds formed between at least one component of the tying layer and at least one component of the adhesive layer, the adhesive layer, the tying layer, and the heat-shrinkable polyolefin sheet arranged and combined to minimize disbondment according to ASTM G 42.

16. The apparatus of claim 15, wherein the heat-shrinkable polyolefin backing is an irradiatively cross-linked heat-shrinkable polyolefin backing.

17. The apparatus of claim 16, wherein the irradiatively cross-linked heat-shrinkable polyolefin backing shrinks by about 10% to about 60%, based on circumferential length, in response to being heated to at least about 60° C.

18. The apparatus of claim 17, wherein the adhesive layer comprises an adhesive selected from a group consisting of mastics, polyurethanes, polyamides, synthetic rubbers and epoxies.

19. The apparatus of claim 18, wherein the heat-shrinkable polyolefin backing comprises a polyolefin selected from a group consisting of polyethylene, polypropylene and blends thereof.

20. The apparatus of claim 19, wherein the heat-shrinkable polyolefin backing is a woven heat-shrinkable polyolefin backing.

21. The apparatus of claim 20, wherein the heat-shrinkable polyolefin sheet, the tying layer, and the adhesive layer are adapted to cover the pipe upon shrinking to substantially seal the pipe from water and water vapors without sealing the pipe from passage of current.

22. A joint-covering sleeve for covering an outer surface of a pipe, the joint-covering sleeve comprising
a polyolefin sheet,
a tying layer, and
an adhesive layer, wherein the trying layer is interposed between and in contact with the polyolefin sheet and the adhesive layer and the tying layer includes tying means for coupling the polyolefin sheet to the adhesive layer to retain the polyolefin sheet and the adhesive layer on a pipe.

23. The joint-covering sleeve of claim 22, wherein the tying means includes an amount of a reactively modified polyolefin dispensed in the tying layer to provide non-reactive compatibilization to the polyolefin sheet.

24. The joint-covering sleeve of claim 22, wherein contact between the tying layer and the adhesive layer causes the reactively modified polyolefin to bond with a polymer making up the adhesive layer.

25. The joint-covering sleeve of claim 22, wherein the tying means provides means for retaining the polyolefin sheet and the adhesive layer on the pipe so that the joint-covering sleeve resists cathodic disbondment according to ASTMG42.

26. The joint-covering sleeve of claim 22, wherein the polyolefin sheet comprises an irradiation cross-linked polymer.
